(19) United States
(12) Patent Application Publication
(10) Pub. No.: US 2025/0155309 A1
(43) Pub. Date: May 15, 2025

(54) Device and Method for Detecting Changes to a Value of a Physical Variable

(71) Applicant: Siemens Aktiengesellschaft, Muenchen (DE)

(72) Inventors: Stefan KLEHR, Rheinzabern (DE); Stefan VON DOSKY, Karlsruhe (DE); Rico BURCKHARDT, Offenbach (DE)

(21) Appl. No.: 18/832,741

(22) PCT Filed: Jan. 19, 2023
(86) PCT No.: PCT/EP2023/051262

§ 371 Date: Jul. 24, 2024

(30) Foreign Application Priority Data
Jan. 26, 2022 (DE) 10 2022 200 869.3

(51) Int. Cl. G01L 23/08; G01L 15/00

(52) U.S. Cl. CPC G01L 23/08; G01L 15/00

(57) ABSTRACT

A device for detecting changes to a value of a physical variable includes a first component that generates a first output signal upon exceeding a threshold value of a rate of change of the value of the physical variable, a second component for determining a physical variable value and for generating a corresponding second output signal, a controller formed as a microprocessor that processes specified commands, a memory, and an energy supply that supplies the second component with energy, the controller reading the first and second output signals, detecting the value of the physical variable at an adaptable measurement rate via the controller supplying the second component with energy according to the provided measurement rate, storing detected values, and supplying the second component with energy in response to receiving the first output signal to detect a present value of the physical variable via the second output signal and store it.

### CROSS-REFERENCE TO RELATED APPLICATIONS

This is a U.S. national stage of application No. PCT/EP2023/051262 filed 19 Jan. 2023. Priority is claimed on German Application No. 10 2022 200 869.3 filed 26 Jan. 2022, the content of which is incorporated herein by reference in its entirety.

### BACKGROUND OF THE INVENTION

### 1. Field of the Invention

The invention relates to an apparatus for detecting changes in a value of a physical variable, a pipeline, through which a fluid can flow, a detection system, a method for detecting changes in a value of a physical variable, use of the apparatus and a computer program product.

### 2. Description of the Related Art

In pipeline networks, such as in the drinking water supply sector, there is the risk of pipe bursts due to pressure surges that can occur as a result of fluid dynamics. This problem occurs comparatively frequently, so that drinking water supply companies have a particular interest in detecting pressure surges and, in particular, locating a possible pipe burst.

In order to avoid pressure surges or at least reduce their intensity, it is known to use so-called mechanical water hammer dampers at various points in the pipeline network.

For example, DE 617 502 C or EP 0 507 705 A1 disclose such apparatuses. Although the water hammer damper can damp pressure surges, it cannot provide information regarding the pressure surge events.

In order to limit the damaging effects of the pressure surges, it is possible within the scope of the planning and the construction of the pipeline networks to take into consideration pre-calculated parameters with respect to material selection and wall thickness of the pipelines, in order to prevent pipe bursts. However, this approach is not practical in most cases, particularly because in so doing ageing processes such as corrosion are not taken into consideration. It is also possible to distribute pressure sensors in the pipeline network and thus to continuously monitor the pressure conditions. Due to the continuous pressure measurement required for this, an adequate energy supply must be provided for each measuring point, which involves a high outlay regarding energy and material given the considerable length of pipeline networks (especially in the drinking water supply sector). In addition, a distributed sensor network is only practicable if the sensors are operated wirelessly. Continuous pressure measurement also consumes a relatively large amount of energy, which in turn severely limits the battery life.

DE 7 040 823 U and DE 6 911 897 U each disclose a pressure switch with switching point adjustment for detecting a pressure value of a fluid.

DE 582 011 A discloses a pressure switch that closes an electrical contact when a specific pressure threshold value of a fluid is exceeded, for example, in order to interrupt the cooling process of a refrigerator.

EP 3 588 042 A1 discloses a pressure element for monitoring a fluid that acts on the pressure element. Here, the pressure element is designed so as to close an electrical circuit caused by a change in pressure that the fluid exerts on the pressure element, regardless of an absolute value of the pressure. In so doing, this electrical circuit acts as a trigger for a downstream pressure sensor. However, the pressure element is only used to recognize relatively large pressure changes.

### SUMMARY OF THE INVENTION

It is an object of the invention to enable detection of changes in a value of a physical variable, which enables a high degree of accuracy simultaneously with low energy outlay.

This and other objects and advantages are achieved in accordance with the invention by an apparatus for detecting changes in a value of a physical variable, a pipeline through which a fluid can flow, a detection system, a method for detecting changes in a value of a physical variable, use of the apparatus and by a computer program product, where the apparatus in accordance with the invention for detecting changes in a value of a physical variable includes:
a first component that is configured to generate a first output signal when a threshold value of a rate of change of the value of the physical variable is exceeded,
a second component that is configured to determine the value of the physical variable and to generate a corresponding second output signal, and
a controller that includes a microprocessor that is configured to process predefined commands, a memory and an energy supply that is configured to supply the second component with energy, where the controller is connected to the first and second components by cable or wirelessly and is configured to read out the first and second output signals.

In this case, the controller is configured to detect the value of the physical variable at an adjustable measurement rate, where the controller supplies the second component with energy in accordance with the specified measurement rate. Furthermore, the controller is configured to store each value that is detected via the second output signal in the memory of the control unit. In addition, the controller is configured to supply the second component with energy immediately in response to receiving the first output signal and regardless of the presently specified measurement rate, in order to detect a present value of the physical variable via the second output signal and store it in the memory. The term “a present value” means that this must not only be determined at a single point in time, but also over a defined period of time, for example, until the criterion of the threshold value being exceeded is no longer applicable. Accordingly, the “present value” in the actual sense can also be a value curve.

The apparatus in accordance with the invention can advantageously determine a present, absolute measured value of the physical variable at a specified measurement rate via the second component and store it in a memory for further processing. This (absolute) measurement can be implemented in a particularly energy-saving manner if a low measurement rate (in measurements per time unit) is selected and if the second component is not supplied with energy during the measurement pause. A slow decrease or increase in the physical variable can thus be detected reliably and with low energy.

The sole use of the second component may not be sufficient for a detection of comparatively rapid changes in the physical variable, because the measurement of the physical variable may be too inaccurate in terms of time due to a relatively high specified measurement rate, i.e., the measurement rate may be selected too low. The control unit of the apparatus in accordance with the invention is therefore connected to a further component (the first component), which is configured to generate a first output signal when a threshold value of a rate of change of the value of the physical variable is exceeded. In other words, the first component is capable of detecting a relative change in the physical variable directly, i.e., without requiring a downstream calculation of differential values, and consequently transmitting a signal to the control unit. In response to the signal received from the first component, the control unit can immediately supply the second component with energy to detect a present value of the physical variable (earlier than by the specified measurement rate). The first component is therefore used to detect relatively rapid changes in the physical variable.

The apparatus in accordance with the invention advantageously combines a temporally finely resolvable detection of a value of a physical variable with a minimized energy outlay.

Preferably, the controller is configured to adjust the measurement rate when a threshold value of a rate of change of previously detected values of the physical variable stored in the memory is exceeded. In other words, the controller can adapt the rate of change to the rate of change of the historical values of the physical variable stored in the memory of the control unit when a threshold value is exceeded. The present rate of change can advantageously be determined by the controller itself using suitable algorithms and compared with the threshold value. However, it is also possible for an external, outsourced computing unit (or outsourced microprocessor) to take on this task and, if necessary, notify the controller that the threshold value has been exceeded. If, for example, a high present rate of change is detected, then the controller can increase the measurement rate in order to resolve the physical variable more accurately in terms of time, which may make it easier to recognize specific characteristics of the physical variable.

As part of an advantageous embodiment of the invention, the apparatus is configured to transfer the values of the physical variable stored in the memory to a higher-level evaluation unit at predefined points in time and/or on request, in particular to a cloud-based evaluation unit.

The first component can be configured to generate an electrical voltage as the first output signal when the threshold value of the rate of change of the value of the physical variable is exceeded due to the effect of a force applied to the first component by the physical variable. This voltage can then be used as the input signal of a special trigger electronics unit, which generates a trigger signal and transmits it to the controller. The trigger signal can then trigger a hardware interrupt at the controller, whereby the controller is informed that the threshold value has been exceeded.

In an advantageous embodiment of the invention, the threshold value of the rate of change of the value of the physical variable is five bar per second, where the physical variable represents a pressure, in particular a pressure of a fluid in a pipeline. The first component can advantageously be ring-shaped. The first component can preferably comprise a material that behaves in accordance with the piezoelectric effect, which reacts to the exertion of a force caused by the pressure change by generating an electrical voltage. Such a material is ferroelectric and has a permanent electric dipole.

The second component is advantageously a pressure sensor, which is used to detect a pressure as a physical value.

In addition to detecting the pressure change, the controller can provide an exact time stamp of the change event and have sensors for detecting parameters, such as temperature, humidity, vibration, brightness.

The task described above is also solved by a pipeline. A fluid can flow through this pipeline, where the pipeline has at least one apparatus as explained above, where the apparatus is arranged in the pipeline such that the first component can detect a rate of change of a pressure of the fluid and the second component can detect the value of the pressure of the fluid in the pipeline. In this pipeline, a pressure change in the fluid pressure can be detected in a particularly advantageous manner, whereupon appropriate measures can be initiated in order to counteract the pressure change. Preferably, the pipeline has a large number of apparatuses such as those described above. This enables the pressure change to be detected at a localized level so that possible countermeasures can be initiated more efficiently and quickly.

The objects and advantages are also achieved in accordance with the invention by a detection system that comprises a plurality of apparatuses as explained above, which are connected to one or more higher-level evaluation units, the apparatuses preferably being arranged in a pipeline.

The objects and advantages are also achieved in accordance with the invention by a method for detecting changes in a value of a physical variable using an apparatus, where the apparatus comprising:
a first component that is configured to generate a first output signal when a threshold value of a rate of change of the value of the physical variable is exceeded,
a second component that is configured to determine the value of the physical variable and to generate a corresponding second output signal,
a controller a microprocessor that is configured to process predefined commands, a memory and an energy supply that is configured to supply the second component with energy, where the controller is connected to the first and second components by cable or wirelessly and is configured for this purpose.

The method in accordance with the invention comprises:
detecting the value of the physical variable at a measurement rate specified by the controller, where the control unit supplies the second component with energy in accordance with the specified measurement rate and stores each value that is detected via the second output signal that is generated by the second component in the memory of the control unit,
in response to receiving a first output signal that is generated by the first component when the threshold value of the rate of change of the value of the physical variable is exceeded, immediately and regardless of the presently specified measurement rate, supplying the second component with energy in order to detect a present value of the physical variable via the second output signal and to store it in the memory of the control unit.

The term “a present value” means that this must not only be determined at a single point in time, but also over a defined period of time, for example, until the criterion of the threshold value being exceeded is no longer applicable.

The measurement rate can be adjusted by the controller when a threshold value of a rate of change of previously detected values of the physical variable stored in the memory is exceeded.

The values of the physical variable stored in the memory can be transferred from the controller to a higher-level evaluation unit at predefined points in time and/or on request, in particular to a cloud-based evaluation unit. The “Narrowband IoT” standard can be used here, for example.

The objects and advantages are also achieved in accordance with the invention by use of an apparatus as explained above, preferably a plurality of such apparatuses, to monitor a pipeline through which fluid flows.

In addition, the objects and advantages are achieved in accordance with the invention by a computer program product comprising commands which, when the program is executed by a processor of a computer, cause the computer to perform a method as explained above.

The above described characteristics, features and advantages of this invention and the manner in which these are achieved are more clearly and more precisely understandable in conjunction with the following description of the exemplary embodiments that is explained in more detail in connection with the figures, in which:

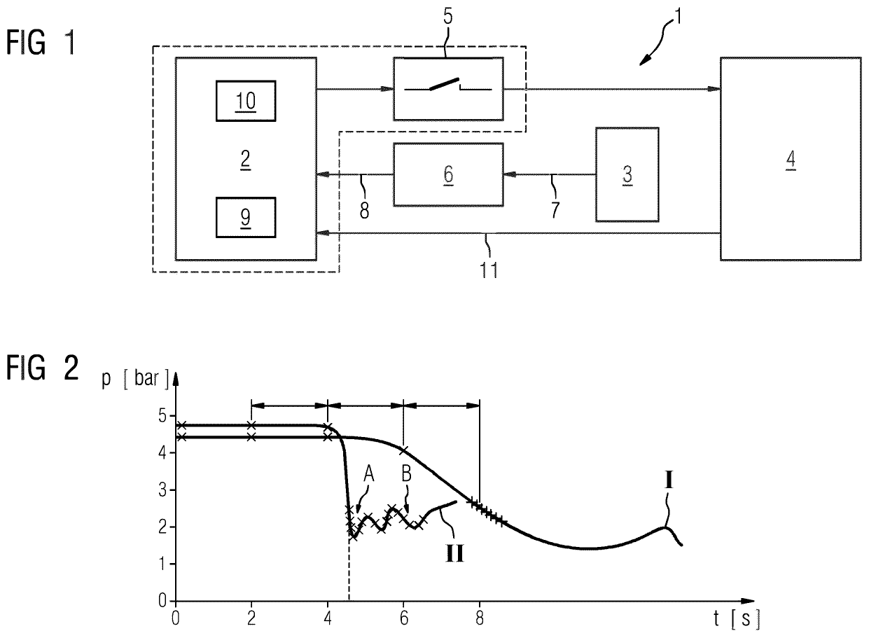

FIG. 1 shows a diagram of an apparatus in accordance with the invention;

FIG. 2 shows a temporal graph of a fluid pressure measured in a pipeline; and

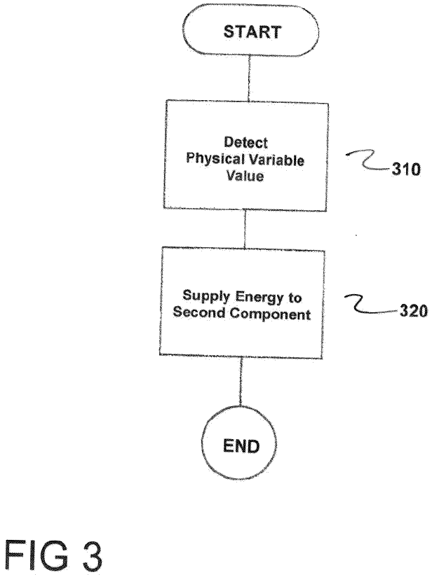

FIG. 3 is a flowchart of the method in accordance with the invention.

### DETAILED DESCRIPTION OF THE EXEMEMPLARY EMBODIMENTS

FIG. 1 shows a diagram of an apparatus 1 in accordance with the invention. The apparatus 1 comprises a controller 2, a first component 3, a second component 4 and a trigger electronics unit 6.

The first component 3 is ring-shaped and has a material that responds to a mechanical force with an electrical voltage in accordance with the piezoelectric effect. The piezo voltage that is generated as a first output signal 7 is directly proportional to a pressure change, for example, of a fluid that is flowing through a pipeline and is exerting a pressure on the first component 3 and on the second component 4. The second component 4 comprises a pressure sensor with which, among other things, the pressure of the fluid that is flowing through the pipeline (not shown) can be determined. The first component 3 can be arranged directly adjacent to the second component 4.

The piezo voltage forming the first output signal 7 is fed into the trigger electronics unit 6 such that, when a specific threshold value of a pressure change in the fluid is exceeded, the piezo voltage 7 applied to the trigger electronics unit 6 is so high that the trigger electronics unit 6 generates a trigger signal 8, which is fed into the controller 2. In the controller, the trigger signal 8 triggers a hardware interrupt, whereby the controller 2 is informed that the pressure change has exceeded the threshold value.

The trigger electronics unit 6 can, for example, have a low-pass filter and a Schmitt trigger in order to provide the functionalities described. A present consumption of the trigger unit can be 3.6 microamperes. The first component can, for example, detect rapid pressure transients from a rate of change of 5 bar per second, whereby the generated piezo voltage 7 is, for example, 20 millivolts.

The controller 2 has a microprocessor 9 that is configured to process predefined commands, a memory 10 and an energy supply 5 that is configured to supply the second component 4 with energy. The controller 2 is connected to both the first component 3 and the second component 4 by cable or wirelessly and is configured to read out the first output signal 7 and a second output signal 11 that is generated by the second component 4.

The controller 2 is also configured to detect the pressure value measured by the second component 4 at an adjustable measurement rate, where the controller 2 supplies the second component 4 with energy via the energy supply 5 in accordance with the specified measurement rate, and to store the pressure value that is detected via the second output signal 11 in the memory 10 of the controller 2. The measurement rate can be one measurement per two seconds, for example. During the measurement pauses, the pressure sensor serving as the second component 4 is completely de-energized and the microcontroller 9 is in an energy-saving low-power mode. In each case, the measurement of a pressure value can take seven milliseconds, for example.

An algorithm is stored in the microcontroller 9 of the controller 2 and the algorithm checks the historical pressure values stored in the memory 10 to determine whether a threshold value of a rate of change of the historical pressure values, in other words a difference between a present and a previous pressure value, has been exceeded. If the threshold value is exceeded, the algorithm is established so as to adjust the measurement rate. If the detected pressure drops rapidly, for example, then the algorithm will increase the measurement rate in order to detect the pressure values with a finer temporal resolution and store them in the memory 10. This increase in the measurement rate can occur gradually, i.e., in small steps, so as not to consume an excessive amount of energy.

In addition, the controller 2 is configured to supply the second component 4 with energy immediately in response to receiving the first output signal 7 and regardless of the presently specified measurement rate, in order to detect a present pressure curve at a high measurement rate via the second output signal 11 and store it in the memory 10. In the event of large, rapid pressure changes, the controller 2 can (therefore) react practically immediately, whereas a purely software-based adjustment of the measurement rate would be delayed.

FIG. 2 shows exemplary graphical plots of pressure curves of a fluid in a pipeline over time. A first curve I represents an actual first pressure curve. The previously described controller 2 specifies a measurement rate of one measurement per two seconds, which is symbolized by the cross markings in curve I. When comparing the pressure value measured after eight seconds with a pressure value measured at six seconds, the algorithm of the controller 2 determines that a specific threshold value of the pressure change has been exceeded. The algorithm then increases the measurement rate in order to record the (further) pressure gradient more closely over time and thereby confirm a possible trigger event with further pressure measurement values. The measurement rate can be increased step-by-step in multiple stages (for example, 2s, 500 ms, 100 ms, 10 ms) in order to detect a significant pressure gradient as quickly as possible and to detect it as a trigger event based on the software and initiate a software trigger.

However, the pressure gradient can be so weak in the further course that the trigger criterion (a defined pressure change must be present for a specific period of time, i.e., the product pressure gradient [bar/s]*time duration [s], i.e., dp/dt*T) is not fulfilled, with the result that no software trigger is triggered and the measurement rate is reset to the slowest measurement rate, such as 2s.

The software trigger causes the microcontroller 9 to increase the measurement rate for a specific, previously defined period of time, such as 60s (for example, to 10 ms), in order to record the further pressure curve at a high sampling rate. The high sampling rate is necessary to achieve the best possible spatial resolution during cross-correlation with the signal curves from adjacent measuring points.

The adaptive increase in the measurement rate is used to add further measured values to the software trigger as quickly as possible to check or reject the defined trigger criterion. The product “pressure gradient*duration” (for example, 0.1 bar/s*3s=0.3 bar) can be used as the trigger criterion. The criterion is also fulfilled if the gradient is greater but of shorter duration (e.g., 0.3 bar/s*1s). Short outliers in the measured values (for example, interference signals) do not immediately lead to a false trigger.

An advantage of the disclosed embodiments of the invention arises, for example, when there is a non-critical pressure fluctuation in a water network (for example, due to sudden high water withdrawal by the consumer). Here, the pressure in the pipe would rise again to the original value (above the threshold value). Owing to the fine measurement resolution of the apparatus 1 in accordance with the disclosed embodiments of the invention, this increase could be recognized quickly and the event could be correctly classified as non-critical.

A second curve II shows a second pressure value curve II, which shows a sharp drop after approximately four seconds. If the apparatus 1 were only structured to performing a purely software-based adjustment of the measurement rate via the algorithm, then this would only detect the pressure drop after six seconds due to the two-second measurement and increase the measurement rate (in range B). However, the apparatus 1 in accordance with the disclosed embodiments of the invention utilizes the trigger by the first component 1 to increase the measurement rate (for example, to 10 ms) in range A, i.e., when the pressure drop occurs. As a result, the course of curve II between areas A and B is precisely recorded, in contrast to conventional apparatuses.

The above-described apparatus 1 enables an energy-saving and simultaneously speed-adaptive detection of pressure changes in a fluid in a pipeline. By using the inventive apparatus 1 and reducing its data and energy requirements, pipe burst detection with battery-operated sensors can be performed over many years. In addition, precise leak detection is possible through cross-correlation (raw pressure data), which is selectively recorded at the time of the pressure drop.

FIG. 3 is a flowchart of the method for detecting changes in the value of a physical variable using an apparatus 1 comprising a first component 3 that is configured to generate a first output signal 7 when a threshold value of a rate of change of the value of the physical variable is exceeded, a second component 4 that is configured to determine the value of the physical variable and to generate a corresponding second output signal 11, a controller 2 including a microprocessor 9 that is configured to process predefined commands, a memory 10 and an energy supply 5 that is configured to supply the second component 4 with energy, where the controller 2 is connected to the first and second components 3, 4 by cable or wirelessly and is configured to read out the first output signal 7 and the second output signal 11.

The method comprises detecting the value of the physical variable at a measurement rate specified by the controller 2 which supplies the second component 4 with energy in accordance with the specified measurement rate and stores the value which is detected via the second output signal 11 which is generated by the second component 4 in the memory 10 of the controller 2 in each case, as indicated in step 320.

Next, the second component 4 is supplied with energy to detect a present value of the physical variable via the second output signal 11 and to store the detected present value of the physical variable in the memory of the control unit 2, immediately and regardless of a presently specified measurement rate, in response to receiving a first output signal 7 that is generated by the first component 3 when the threshold value of the rate of change of the value of the physical variable is exceeded, as indicated in step 310.

Although the invention has been illustrated and described in more detail by the preferred exemplary embodiment, the invention is not limited by the disclosed example and other variations can be derived from it by the skilled person without departing from the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An apparatus for detecting changes in a value of a physical variable, comprising:
a first component which is configured to generate a first output signal when a threshold value of a rate of change of the value of the physical variable is exceeded;
a second component which is configured to determine the value of the physical variable and to generate a corresponding second output signal; and
a controller including a microprocessor which is configured to process predefined commands, a memory and an energy supply which is configured to supply the second component with energy, the controller being connected to the first and second components by cable or wirelessly and being configured to read out the first output signal and the second output signal;
wherein the controller is further configured to detect the value of the physical variable at a customizable measurement rate, the controller supplying the second component with energy in accordance with the specified measurement rate, and further configured to store a value which is detected via the second output signal in the memory of the controller; and
wherein the controller is configured to supply the second component with energy immediately in response to receiving the first output signal and regardless of a presently specified measurement rate, in order to detect a present value of the physical variable via the second output signal and store the present value of the physical variable in the memory.

17. The apparatus as claimed in 16, wherein the controller is configured to adjust the measurement rate when a threshold value of a rate of change of previously detected values of the physical variable stored in the memory is exceeded.

18. The apparatus as claimed in claim 16, wherein the apparatus is configured to transfer the values of the physical variable stored in the memory to a higher-level evaluation unit at least one of (i) at predefined points in time and (ii) on request.

19. The apparatus as claimed in claim 17, wherein the apparatus is configured to transfer the values of the physical variable stored in the memory to a higher-level evaluation unit at least one of (i) at predefined points in time and (ii) on request.

20. The apparatus as claimed in claim 16, wherein the higher-level evaluation unit comprises a cloud-based evaluation unit.

21. The apparatus as claimed in claim 16, wherein the first component is configured to generate an electrical voltage as the first output signal when the threshold value of the rate of change of the value of the physical variable is exceeded due to an effect of force applied to the first component by the physical variable.

22. The apparatus as claimed in claim 21, wherein the threshold value of the rate of change of the value of the physical variable is five bar per second; and wherein the physical variable represents a pressure, in particular a pressure of a fluid in a pipeline.

23. The apparatus as claimed in claim 22, wherein the pressure comprises a pressure of a fluid in a pipeline.

24. The apparatus as claimed in claim 21, wherein the first component is ring-shaped.

25. The apparatus as claimed in claim 22, wherein the first component is ring-shaped.

26. The apparatus as claimed in claim 16, wherein the second component is a pressure sensor for detecting a pressure as a physical value.

27. A pipeline through which a fluid flows and which includes at least one apparatus as claimed in claim 16, wherein the apparatus is arranged in the pipeline such that the first component detects a rate of change of a pressure of the fluid and the second component detects the value of the pressure of the fluid in the pipeline.

28. The pipeline as claimed in claim 27, further comprising:
a plurality of apparatuses for respectively detecting changes in a value of a physical variable, each of the plurality of apparatuses comprising:
a first component which is configured to generate a first output signal when a threshold value of a rate of change of the value of the physical variable is exceeded;
a second component which is configured to determine the value of the physical variable and to generate a corresponding second output signal; and
a controller including a microprocessor which is configured to process predefined commands, a memory and an energy supply which is configured to supply the second component with energy, the controller being connected to the first component and the second component by cable or wirelessly and being configured to read out the first output signal and the second output signal;
wherein the controller is further configured to detect the value of the physical variable at a customizable measurement rate, the controller supplying the second component with energy in accordance with the specified measurement rate, and further configured to store a value which is detected via the second output signal in the memory of the controller; and
wherein the controller is configured to supply the second component with energy immediately in response to receiving the first output signal and regardless of a presently specified measurement rate, in order to detect a present value of the physical variable via the second output signal and store the present value of the physical variable in the memory.

29. A detection system, comprising:
a plurality of apparatuses for respectively detecting changes in a value of a physical variable, each of the plurality of apparatuses comprising:
a first component which is configured to generate a first output signal when a threshold value of a rate of change of the value of the physical variable is exceeded;
a second component which is configured to determine the value of the physical variable and to generate a corresponding second output signal; and
a controller including a microprocessor which is configured to process predefined commands, a memory and an energy supply which is configured to supply the second component with energy, the controller being connected to the first component and the second component by cable or wirelessly and being configured to read out the first output signal and the second output signal;
wherein the controller is further configured to detect the value of the physical variable at a customizable measurement rate, the controller supplying the second component with energy in accordance with the specified measurement rate, and further configured to store a value which is detected via the second output signal in the memory of the controller;
wherein the controller is configured to supply the second component with energy immediately in response to receiving the first output signal and regardless of a presently specified measurement rate, in order to detect a present value of the physical variable via the second output signal and store the present value of the physical variable in the memory;
wherein the plurality of apparatuses are each connected to at least one higher-level evaluation unit; and
wherein the plurality apparatuses are arranged in a pipeline through which a fluid flows such that the first component detects a rate of change of a pressure of the fluid and the second component detects the value of the pressure of the fluid in the pipeline.

30. A method for detecting changes in a value of a physical variable using an apparatus comprising a first component which is configured to generate a first output signal when a threshold value of a rate of change of the value of the physical variable is exceeded, a second component which is configured to determine the value of the physical variable and to generate a corresponding second output signal, a controller including a microprocessor which is configured to process predefined commands, a memory and an energy supply which is configured to supply the second component with energy, the controller being connected to the first and second components by cable or wirelessly and being configured to read out the first output signal and the second output signal, the method comprising:
detecting the value of the physical variable at a measurement rate specified by the controller which supplies the second component with energy in accordance with the specified measurement rate and stores the value which is detected via the second output signal which is generated by the second component in the memory of the controller in each case; and
supplying the second component with energy to detect a present value of the physical variable via the second output signal and to store said detected present value of the physical variable in the memory of the controller, immediately and regardless of a presently specified measurement rate, in response to receiving a first output signal which is generated by the first component when the threshold value of the rate of change of the value of the physical variable is exceeded.

31. The method as claimed in claim 30, wherein the measurement rate is adjustable by the controller when a threshold value of a rate of change of previously detected values of the physical variable stored in the memory is exceeded.

32. The method as claimed in claim 30, wherein the values of the physical variable stored in the memory are transferrable from the controller to a higher-level evaluation unit at least one of (i) at predefined points in time and (ii) on request, in particular to a cloud-based evaluation unit.

33. The method as claimed in claim 31, wherein the values of the physical variable stored in the memory are transferrable from the controller to a higher-level evaluation unit at least one of (i) at predefined points in time and (ii) on request.

34. The method as claimed in claim 32, wherein the higher-level evaluation unit comprises a cloud-based evaluation unit.

35. The method as claimed in claim 30, wherein at least one apparatus is utilized to monitor a pipeline through which a fluid flows.

36. A non-transitory computer readable medium encoded with program commands which, when executed by a processor of a computer cause the computer to detect changes in a value of a physical variable using an apparatus comprising a first component which is configured to generate a first output signal when a threshold value of a rate of change of the value of the physical variable is exceeded, a second component which is configured to determine the value of the physical variable and to generate a corresponding second output signal, a controller including a microprocessor which is configured to process predefined commands, a memory and an energy supply which is configured to supply the second component with energy, the controller being connected to the first and second components by cable or wirelessly and being configured to read out the first output signal and the second output signal, the program command comprising:
program code for detecting the value of the physical variable at a measurement rate specified by the controller which supplies the second component with energy in accordance with the specified measurement rate and stores the value which is detected via the second output signal which is generated by the second component in the memory of the controller in each case; and
program code for supplying the second component with energy to detect a present value of the physical variable via the second output signal and to store said detected present value of the physical variable in the memory of the controller, immediately and regardless of a presently specified measurement rate, in response to receiving a first output signal which is generated by the first component when the threshold value of the rate of change of the value of the physical variable is exceeded.
